(19) United States
(12) Patent Application Publication
(10) Pub. No.: US 2026/0225266 A1
(43) Pub. Date: Aug. 6, 2026

(54) WRIST MECHANISM FOR A ROBOT ARM

(71) Applicant: Boston Dynamics AI Institute LLC, Cambridge, MA (US)

(72) Inventors: Gregory Wei-Zhi Xie, Somerville, MA (US); Nicolas Enrique Rojas Libreros, Belmont, MA (US)

(21) Appl. No.: 19/043,948

(22) Filed: Feb. 3, 2025

(51) Int. Cl. B25J 17/02; B25J 9/10

(52) U.S. Cl. CPC B25J 17/0275; B25J 9/104

(57) ABSTRACT

Among other things, a robotic system includes a base, a platform, a first actuator, a second actuator, a universal joint, and an additional joint. One end of a first universal joint part of the universal joint is coupled to the base and one end of a second universal joint part of the universal joint is coupled to the base. the first and second additional joint parts are configured to swivel around axes that are coincident with a center of the universal joint. At least the platform, the first universal joint part, and the first additional joint part are operable to perform a motion around the additional joint.

### TECHNICAL FIELD

The subject matter described herein relates to a wrist mechanism for a robot arm.

### BACKGROUND

Conventional robotic systems often incorporate mechanisms to control motion and manipulate objects with precision. Many robotic systems rely on joint mechanism to achieve multiple degrees of freedom (DOF), allowing robotic arms to perform tasks such as object manipulation, assembly, navigation, etc., in various applications ranging from industrial automation to robotics in everyday life. These systems typically utilize serial combinations of actuators and linkages to enable controlled movement. However, such design can result in complex mechanisms that require significant synchronization between components.

Other robotic systems rely on parallel or serial joint configurations to achieve coordinated movement. These configurations necessitate precise control of multiple actuators to replicate complex motions. While effective, these systems can lead to challenges in maintaining alignment during dynamic operations.

### SUMMARY

A wrist mechanism for a robotic arm is provided, the robotic arm being capable of performing highly coordinated explosive movements.

In one embodiment, a robotic system is provided. The robotic system can have a base, a platform, a first actuator, and a second actuator. The robotic system can also have a universal joint and an additional joint. The Universal joint can include a first universal joint part and a second universal joint part. The additional joint can include a first additional joint part and a second additional joint part. The axis of the additional joint is coincident with the center of the universal joint. The first universal joint part of the universal joint can be coupled to the platform at one end. The second universal joint part of the universal joint can be coupled to the base at one end. The first and second additional joint parts are configured to swivel around axes that are coincident with the center of the universal joint. The second additional joint part of the additional joint can be fixedly positioned at an angle around the axis of the additional joint. Subsequently, at least the platform, the first universal joint part of the universal joint, and the first additional joint part of the additional joint is configured to perform a motion around the additional joint.

One or more of the following features can be included in any feasible combination. For example, the platform can be positioned in a vertical orientation that aligns with the axis of the additional joint that is perpendicular to the universal joint axes. The platform can maintain the vertical orientation aligning with the axis of the additional joint as the additional joint swivels around the universal joint axes.

In some examples, the additional joint is configured to swivel around the axis based on an operation of the first actuator. The first additional joint part of the additional joint is further configured to perform the motion around the additional joint upon the fixing of the second additional joint part of the additional joint at the angle around the axis of the additional joint. At least the platform, the first universal joint part of the universal joint, and the first additional joint part of the additional joint is configured to perform the motion relative around the additional joint based on an operation of the second actuator. In certain aspects, the first actuator is positioned adjacent to the base. The second actuator is positioned between the first and second additional joint parts.

In some examples, the additional joint is coupled to the universal joint. The coupling includes a coupling between the first additional joint part of the additional joint and the first universal joint part of the universal joint using a first bearing and a coupling between the second additional joint part of the additional joint and the second universal joint part of the universal joint using a second bearing. The first additional joint part of the additional joint is configured to swivel around the axis of the additional joint using the first bearing, while the second additional joint part of the additional joint is configured to swivel around the axis of the additional joint using the second bearing.

In some examples, the second additional joint part is configured to be fixedly positioned at an angle around the axis of the additional joint between −90 degrees to 90 degrees. At least the platform, the first universal joint part of the universal joint, and the first additional joint part of the additional joint is configured to perform the motion around the additional joint within a range of motion between −90 degrees to 90 degrees relative to the axis.

In some examples, the universal joint can include a hollow spider positioned between the first and the second universal joint part of the universal joint. The hollow spider is configured to provide a connection between the first and the second universal joint parts of the universal joint and allows for the passage of cables through the joint.

In another embodiment, a robotic system is provided. The robotic system can include a base, a platform, a first actuator, and a second actuator. The robotic system can also include a universal joint and an additional joint. The Universal joint can include a first universal joint part and a second universal joint part. The additional joint can include a first additional joint part and a second additional joint part. The axis of the additional joint is coincident with the center of the universal joint. The robotic system can further include a drive system. The first universal joint part of the universal joint can be coupled to the platform at one end. The second universal joint part of the universal joint can be coupled to the base at one end. The first and second additional joint parts are configured to swivel around axes that are coincident with the center of the universal joint. The second additional joint part of the additional joint can be fixedly positioned at an angle around the axis of the additional joint. The drive system can be coupled to the second additional joint part of the additional joint and the arm. The drive system is configured to control motion from the second actuator to the additional joint, thereby enabling at least the platform, the first universal joint part of the universal joint, and the first additional joint part of the additional joint to perform a motion around the additional joint.

One or more of the following features can be included in any feasible combination. For example, the second actuator is positioned adjacent to another end of the arm.

In some examples, the angle around the axis of the additional joint is between −90 degrees to 90 degrees. At least the base, the first universal joint part of the universal joint, and the first additional joint of the additional joint is configured to perform the motion around the additional joint within a range of motion between −90 degrees to 90 degrees.

In some examples, the drive system can include a first pulley and a second pulley. The first pulley can be coupled to the first additional joint part of the additional joint. The first pulley can be positioned adjacent to the universal joint and the additional joint. The second pulley can be coupled to the second additional joint part of the additional joint. The second pulley is positioned proximate to the second actuator. The drive system can also include a guide member and a carriage. The guide member can be affixed to the carriage. The carriage can be movably coupled to an extending shaft of the second actuator. The axis that the extending shaft extends along is coincident with the center of the universal joint. The drive system can further include a flexible transmission element operatively connected between the first pulley and the second pulley along the axis of the extending shaft of the second actuator. The flexible transmission element can be displaced using the guide member, causing at least the platform, the first universal joint part of the universal joint, and the first additional joint part of the additional joint to perform the motion around the additional joint. In certain aspects, the flexible transmission element includes a continuous cable or belt.

In some examples, the drive system can include multiple rigid transmission elements. The multiple rigid transmission elements can be operatively connected between the additional joint and the second actuator. A first rigid transmission element of the multiple rigid transmission element can have one end pivotally coupled to the first additional joint part of the additional joint. A second rigid transmission element can have one end pivotally coupled to the second additional joint part of the additional joint and another end pivotally coupled to the first rigid transmission element. A third rigid transmission element can have one end affixed to the carriage and another end pivotally coupled to the second transmission element.

Some advantages of this technology are as follows. It enables the performance of an explosive motion without the need to synchronize wrist trajectories in situations where there is a linear relationship between radial/ulnar deviation and a flexion motion (oblique motion). It provides better control over the axis relative to which the oblique motion can be performed, e.g., without the need to, in some situations, change a location or orientation of, e.g., the wrist/base.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIG. 1A is a schematic diagram of a robotic system according to one embodiment;

FIG. 1B is a schematic representation of an exemplary mechanical topology of the robotic system described in FIG. 1A.

FIG. 2 is a cross-sectional view of a wrist portion of the robotic system described in FIG. 1A;

FIG. 3 is a schematic diagram of a flexion and extension movement of a base;

FIG. 4A is a schematic diagram of a robotic system with a drive system according to one embodiment;

FIG. 4B is a side perspective view of the robotic system described in FIG. 4A in a natural position;

FIG. 4C is a front perspective view of the robotic system described in FIG. 4A in motion performed;

FIG. 4D is a rear perspective view of the robotic system described in FIG. 4A in motion performed;

FIG. 5A is a schematic diagram of a robotic system according to one embodiment;

FIG. 5B is a schematic diagram of a robotic system according to one embodiment;

FIG. 6A is a schematic diagram of a robotic system according to one embodiment;

FIG. 6B is a schematic diagram of a robotic system according to one embodiment;

FIG. 7 is a schematic diagram of a robotic system according to one embodiment; and

FIG. 8 is a block diagram of an example controller that can be used with aspects of this disclosure.

### DETAILED DESCRIPTION

Certain illustrative embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting illustrative embodiments and that the scope of the present invention is defined solely by the claims. The features illustrated or described in connection with one illustrative embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Robotic wrists in conventional robotic system struggle to replicate the highly coordinated and complex movements observed in human wrists, such as, without limitation, the dart-thrower's motion (DTM). DTM involves rotation around an oblique axis that combines flexion/extension and radial/ulnar deviation, motions critical for many activities of daily living (ADLs), such as throwing, pouring, or hammering. Conventional robotic systems require multiple actuators with synchronized trajectories to achieve these movements, leading to increased mechanical complexity and inefficiencies.

The present disclosure provides a robotic system capable of performing such motions with a two-degree-of-freedom (DOF) wrist mechanism. The robotic system includes a base, a platform, a first actuator, and a second actuator. The robotic system can also include a universal joint having a first universal joint part and a second universal joint part, as well as an additional joint having a first additional joint part and a second additional joint part. The axis of the additional joint is coincident with the center of the universal joint. The platform can be coupled to one end of the first universal joint part of the universal joint. The base can be coupled to one end of the second universal joint part of the universal joint. The first and second additional joint parts are configured to swivel around axes that are coincident with the center of the universal joint. The robotic system (i.e., at least the platform, the first universal joint part of the universal joint, and the first additional joint part of the additional joint) can perform a motion around the additional joint as a result of the swivel motion.

The robotic system described herein enables the performance of an explosive motion without the need to synchronize wrist trajectories in situations where there is a linear relationship between multiple motions, such as radial/ulnar deviation and flexion motion in DTM. Additionally, the robotic system described herein reduces mechanical complexity, power consumption, and reflected inertia by consolidating high-performance motion control into a single actuator system and allowing control over the orientation of the axis of compliance without changing, in some cases, the orientation of the base.

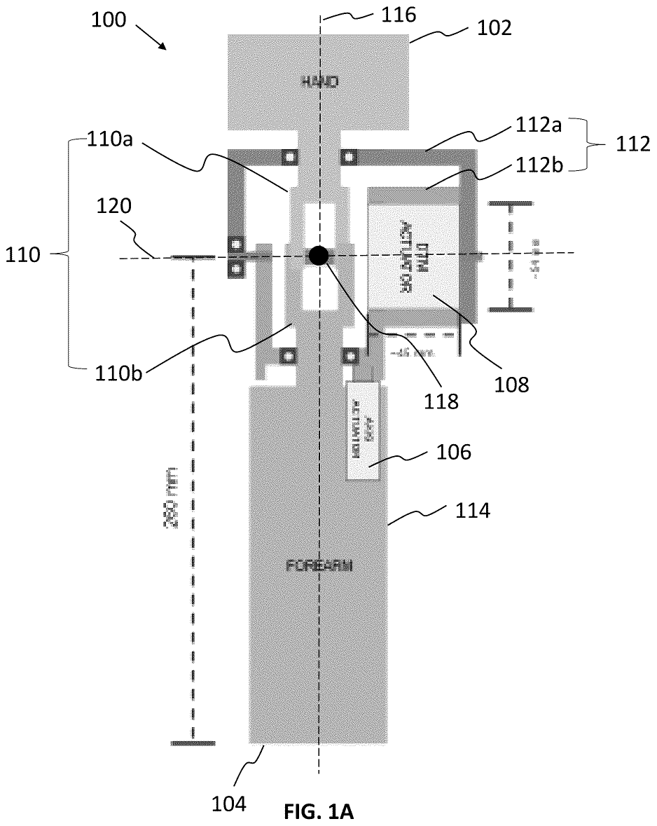

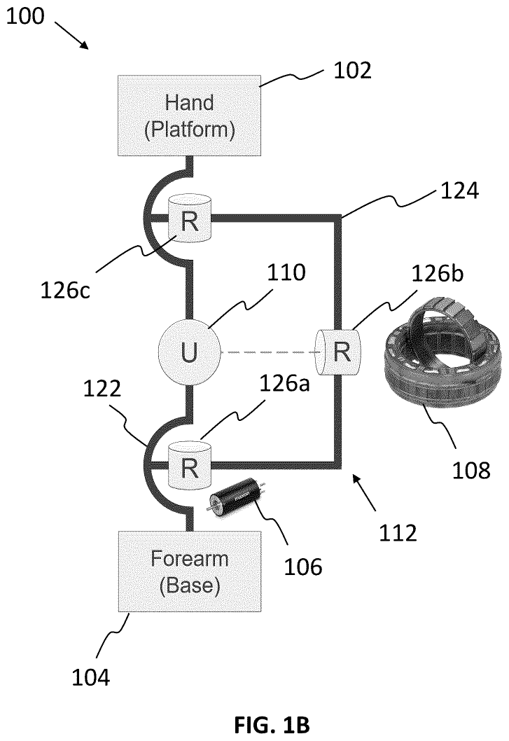

With reference now to FIG. 1A, an illustrative embodiment of a robotic system 100 is shown. The illustrated robotic system 100 generally includes a platform 102, a base 104, a first actuator 106, a second actuator 108, a universal joint 110 having a first universal joint part 110a and a second universal joint part 110b, and an additional joint 112 having a first additional joint part 112a and a second additional joint part 112b. The platform 102 refers to a structural component that serves as a primary attachment point for the base 104. The base 104 is a support of the robotic wrist (e.g., the universal joint 110 and the additional joint 112) and the platform 102.

The platform 102 is coupled to an upper end of the first universal joint part 110a (i.e., a top portion) of the universal joint 110, while the base 104 is attached to a lower end of the second universal joint part 110b (i.e., a bottom portion) of the universal joint 110. In some implementations, the base 104 can be a segment of a larger robotic system. The base 104 may include a housing 114 having an elongate, upright cylindrical hollow body. The housing 114 may define conduits or grooves for cables, and chambers for other components that enable the operation of the mounted platform 102. For example, the housing 114 can be partially enclosed, allowing it to protect and secure components such as the first actuator 106, the second actuator 108, or electrics for controlling the movement and the orientation of the robotic system 100.

According to some implementations, the platform can represent a “hand” (or a gripper) attached to a terminal end of the base 104, configured to interact with one or more external objects or perform one or more specific tasks. In such implementations, the base 104 represents an arm or at least a portion of the arm (e.g., a forearm). However, the platform 102 is not limited to this configuration and may include other structures, such as, without limitation, tool holder, end-effector, sensors, or any devices that requires motion, dependent on the specific implementation or application of the robotic system 100 as described herein.

The additional joint is coupled to the universal joint and configured to swivel around an axis 116. The axis 116 is a central, vertically oriented axis that extends, for example, through the first and the second universal joint parts 110a-b of the universal joint 110, as well as through the first and the second additional joint parts 112a-b. The axis 116 is coincident with the center of the universal joint. The swivel motion of the additional joint 112 around the axis 116 allows the robotic system 100 to adjust the wrist orientation without affecting the overall alignment of the system. For example, the platform 102 can be positioned in a vertical orientation that aligns with the axis 116. The swivel motion can occur as the second additional joint part 112b rotates around the axis 116. The first additional joint part 112a can rotate around the axis 116 simultaneously with the rotation of the second additional joint part 112b due to the coupling; the base maintains its vertical orientation aligning with the axis 116 during the swivel motion. However, when the platform 102 and the base 104 are not in vertical positions, for example, when the platform 102 and the base 104 are tilted, the additional joint can still swivel around the axis defined by the couplings between the additional joint 112 and the universal joint 110. The base 104, in this case, is not stationary and undergoes some movement.

The coupling between the additional joint 112 and the universal joint 110 adds a controlled degree of freedom along a single axis. Specifically, the first additional joint part 112a (i.e., a top portion) of the additional joint 112 encapsulates or shelters the first universal joint part 110a of the universal joint 110, and the second additional joint part 112b (i.e., a bottom portion) of the additional joint 112 encapsulates or shelters the second universal joint part 110b of the universal joint 110. The first additional joint part 112a can be pivotally connected to the second additional joint part 112b through one or more pins or a central axle at one or more openings in both the first and the second additional joint parts 112a-b.

For example, FIG. 1B illustrates a schematic representation of an exemplary mechanical topology of the robotic system 100. The robotic system 100 includes a wrist mechanism having two distinct branches 122, 124 that work together to enable motions described herein. In some implementations, the first branch 122 includes the universal joint 110 (U), while the second branch 124 includes the additional joint 112. The universal joint 110 is entirely passive, meaning it does not contain any actuated components (e.g., actuators). The universal joint 110 is positioned between the hand (platform 102) and the forearm (base 104), allowing for free, multi-axial movement without the need for active controls. To this end, the universal joint 110 enables the wrist mechanism to adapt to the changing orientation of the hand or the forearm. In some instances, the additional joint 112 includes a chain of three revolute joints 126a-c (R-R-R) configured to provide the actuation required by the wrist mechanism. The first revolute joint 126a (proximate to the forearm) and the second revolute joint 126b (aligned with the universal joint 110) are actively actuated by dedicated actuators (e.g., first actuator 106 and second actuator 108); however, it should be noted that the third revolute joint 126c (near the hand) remains passive. Accordingly, the third revolute joint 126c can responds to the forces and torques generated by the actuated additional joint 112.

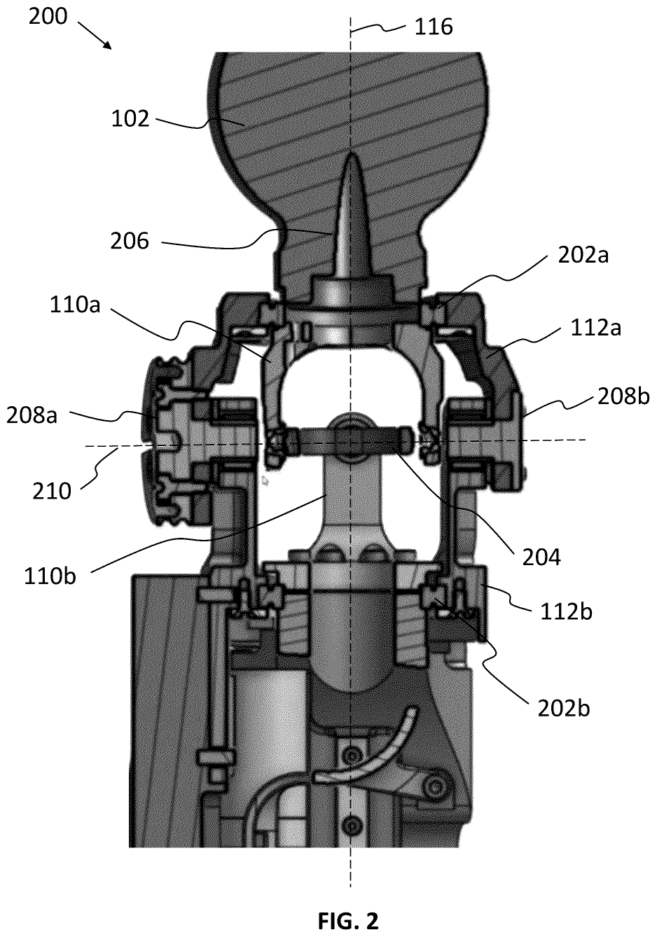

FIG. 2 shows a cross-sectional view of a wrist portion 200 of the robotic system 100. According to some implementations, to decouple swivel motion between the universal joint 110 and the additional joint 112, one or more bearings can be used. For example, the first additional joint part 112a of the additional joint 112 can be movably coupled to the first universal joint part 110a of the universal joint 110 using a first bearing 202a. The first bearing 202a is positioned adjacent to the upper end of the first universal joint part 110a of the universal joint 110 and interfaces with the first additional joint part 112a of the additional joint 112. Similarly, the second additional joint part 112a of the additional joint 112 can be movably coupled to the second universal joint part 110b of the universal joint 110 using a second bearing 202b. The second bearing 202b is positioned adjacent to the lower end of the second universal joint part 110b of the universal joint 110 and interfaces with the second additional joint part 112b of the additional joint 112. The bearings allow the additional joint 112 to rotate independently around the axis 116 without transferring rotational forces to the universal joint 110 or any of its connected components. Accordingly, during the swivel motion, the additional joint 112 can swivel around the axis 116 using the first and the second bearings 202a-b while the universal joint 110 and the platform 102 attached thereof remain in their original position relative to the axis 116, thereby minimizing the torque required by the universal joint 110.

Unlike conventional universal joints, which typically use a block or spider element to connect the two parts, the first universal joint part 110a and the second universal joint part 110b are connected using a hollow spider 204 positioned between the two parts. According to some implementations, the hollow spider 204 includes four connection points (not labeled for clarity) around its circumference. Each one of the connection points can be located at equidistant positions around the circumference to accommodate rotational motion in two perpendicular planes similar to conventional universal joints. Specifically, the first universal joint part 110a and the second universal joint part 110b are each pivotally coupled to two of the four connection points on the hollow spider 204. For example, the first universal joint part 110a is connected to two opposing connection points on the hollow spider 204 along a first rotational axis. The second universal joint part 110b is connected to the remaining two opposing connection points on the hollow spider 204 along a second rotational axis, wherein the second rotational axis is perpendicular to the first rotational axis. The hollow spider 204 provides a passage for cables through the universal joint.

In some implementations, the platform 102 can be removably attached to the first universal joint part 110a of the universal joint 110 through at least one interface feature 206. For example, the at least one interface feature 206 can include an insertion-type fitting where the interface feature 206 is configured to extend certain length into a corresponding cavity or recess formed in the platform 102, providing a secure mechanical engagement between the platform 102 and the first universal joint part 110a of the universal joint 110. Other types of interface features, such as flange coupling, threaded fasteners, or a key-and-slot mechanism may also be used depending on the structural and operational requirements of the robotic system 100. In some instances, the interface feature 206 can take the form of a cylindrical or tapered projection that fits snugly within the cavity of the platform 102. Alternatively, the platform 102 is secured to the base through fasteners at the first universal joint part 110a of the universal joint 110. The platform 102 also clamps onto the inner part of the first bearing 202a after tightening the fasteners.

Additionally, coupling components 208a-b are used to structurally connect the first and the second additional joint part 112a-b of the additional joint 112, yet enabling pivotal motion between the two parts about an axis of rotation 210 that is perpendicular to the axis 116. Specifically, a first central pin or axle (i.e., the first coupling component 208a) that passes through an aligned opening in both the first additional joint part 112a and the second additional joint part 112b on one side, and a second central pint or axle (i.e., the second coupling component 208b) passes through another aligned opening in both the first additional joint part 112a and the second additional joint part 112b on an opposite side. The first and the second central pins or axles, as well as the hollow spider 204, are positioned coaxially along the axis of rotation 210. In some cases, the coupling components 208a-b are supported by the structural material of the first and second additional joint parts 112a-b at their respective ends. During operation, the first additional joint part 112a of the additional joint 112 is configured to pivot relative to the second additional joint part 112b of the additional joint 112. The first universal joint part 110a of the universal joint 110 is also configured to rotate around the axis 210 due to the coupling at the upper end. Both the second additional joint part 112b of the additional joint 112 and the second universal joint part 110b of the universal joint 110 remain static.

Referring back to FIG. 1A, it should be noted that the swivel motion is based on an operation of the first actuator 106. In some implementations, the first actuator 106 can be positioned adjacent to the additional joint 112. The first actuator 106 can be operatively connected to the second additional joint part 112b of the additional joint. For example, the first actuator 106 can be a high-performance motor capable of delivering torque for controlled rotational motion. In some instances, the first actuator 106 is equipped with a direct-drive system to rotate the second additional joint part 112b of the additional joint part at its circumference. Specifically, the first actuator 106 can include a capstan cable drive. The first actuator 106 drives the second additional joint part 112b of the additional joint 112 by controlling rotational motion of the cable drive to produce the swivel motion around the axis 116. In some instances, the additional joint 112 is configured to swivel around the axis 116 within a range of motion between −90 degrees to 90 degrees.

In some cases, the first actuator 106 can be mounted within the housing 114 of the base 104. The housing 114 can provide structural support and protection for the first actuator 106 while maintaining alignment with the second additional joint part 112b of the additional joint 112. For example, the first actuator 106 can be securely affixed to an inner surface of the housing 114 via one or more mounting brackets or fasteners to ensure stability during operation.

In order to perform the DTM effectively, the second additional joint part of the additional joint is configured to be fixedly positioned at a location relative to the axis 116 prior to initiating a motion, such as an oblique motion. The oblique motion is a type of motion where the platform 102 moves at an angle to the horizontal, i.e., a combination of a horizontal motion and a vertical motion along an axis 118 that is oriented, as shown in FIG. 1A, perpendicular to the plane of the page, extending outward from the page toward the viewer. The base 104 moves along an axis 120 (e.g., 210). For example, the additional joint 112 can facilitate a coordinated rotation between the first additional joint part 112a and the additional joint part 112b during the oblique motion. As the first additional joint part 112a of the additional joint 112 rotates relative to the second additional joint part 112b of the additional joint around the axis 120, the platform 102 creates a trajectory that corresponding to flexion or extension of the platform 102. The swivel motion around the axis 116 adjusts the orientation of the axis of rotation 120 (shared by the universal joint 110 and the additional joint 112) and the fixing of the second additional joint part 112b of the additional joint 112 at a predefined location establish a desired orientation of the axis of compliance to ensure that the subsequent motion can be performed along the intended rotational plane.

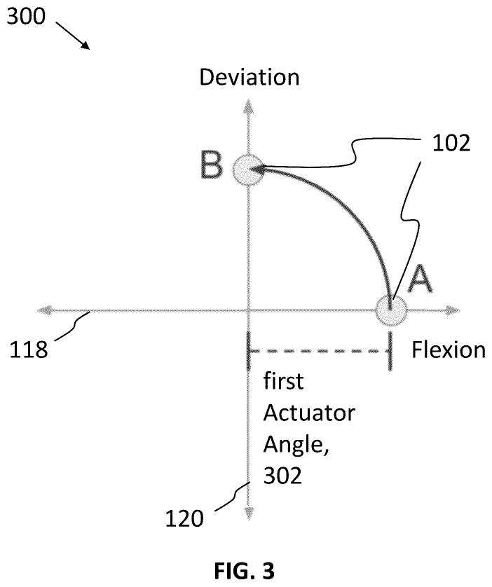

FIG. 3 illustrates a schematic representation 300 of the flexion and extension movement of the platform 102. The horizontal x-axis of the two-dimensional (2D) coordinate system represents the axis 118, while the vertical y-axis represents the axis 120. It should be noted that the axes as shown in FIG. 3 do not rotate with the rotation of the first and the second additional joint part 112a-b of the additional joint. The platform 102 can move along a curved trajectory from point A to point B. The curved trajectory corresponds to a wrist circumduction motion. Similarly, the platform 102 can move along the curved trajectory from point B back to point A. In some instances, the movement along the curved trajectory can be solely driven by the actuation of the first actuator 106 while the second actuator 108 is held still. The first actuator 106, as described in further detail below, may generate a rotational displacement defined by a first actuator angle 302 which represent the extent of the flexion/deviation motion required for the platform 102 to transition between the two positions (point A and point B) along the curved trajectory. Such wrist circumduction motion allows the platform 102 to replicate, for example, a natural wrist motion that is part of the DTM.

Referring back to FIG. 1A, at least the platform 102, the first universal joint part 110a of the universal joint 110, the first additional joint part 112a of the additional joint 112, and the base 104 is configured to perform the motion around the additional joint. The motion includes, for example, an oblique motion relative to the axis after the fixing of the second additional joint part 112b of the additional joint 112 at the predefined location. According to some implementations, the first additional joint part 112a of the additional joint 112 is configured to perform the oblique motion relative to the axis 116 upon the fixing of the second additional joint part 112b of the additional joint 112 at the predefined location relative to the axis 116. Such performance of the oblique motion is based on operation of the second actuator 108. In some instances, the second actuator 108 can be positioned adjacent to the universal joint 110 and the additional joint 112. Specifically, the second actuator 108 can be integrated with either coupling component 208a/b (as shown in FIG. 2) and positioned at either side of the additional joint 112. For example, the second actuator 108 includes a rotary motor operatively connected to the first coupling component 208a, or a second coupling component 208b, or both to impart torque generated by the rotary motor about the axis of rotation 120 (or axis 210) while maintaining the second additional joint part 112b of the additional joint 112, as well as the second universal joint part 110b of the additional joint in stationary at the predefined location. In some instances, at least the platform 102, the first universal joint part 110a of the universal joint 110, the first additional joint part 112a of the additional joint 112, and the base 104 is configured to perform the oblique motion relative to the axis 116 within a range of motion between −90 degrees to 90 degrees relative to the axis.

The configuration in which the second actuator 108 is positioned adjacent to the universal joint 110 and the additional joint 112, while compact, may contribute to increased arm inertia due to the placement of the actuator's mass near the distal end of the base 104. Arm inertia refers to the resistance of the base 104 to changes in its motion due to its mass and the distribution of that mass relative to the axis 116, 118, and 120. Inertia is directly proportional to both the mas of the components and the distance of that mass from the axis 116, 118, and 120. When the second actuator 108 is positioned adjacent to the universal joint 110 and the additional joint 112, it contributes to the arm's overall inertia because the second actuator 108 adds mass near one end of the base 104. The mass becomes part of the arm's load during dynamic motion. As the platform 102 or the base 104 moves, the second actuator's weight exerts greater resistance to acceleration or deceleration, particularly during high-speed or explosive movements e.g., the throwing motion. The resistance requires more torque from the actuators to overcome, which in turn increases power consumption and reduce operational efficiency of the robotic system 100.

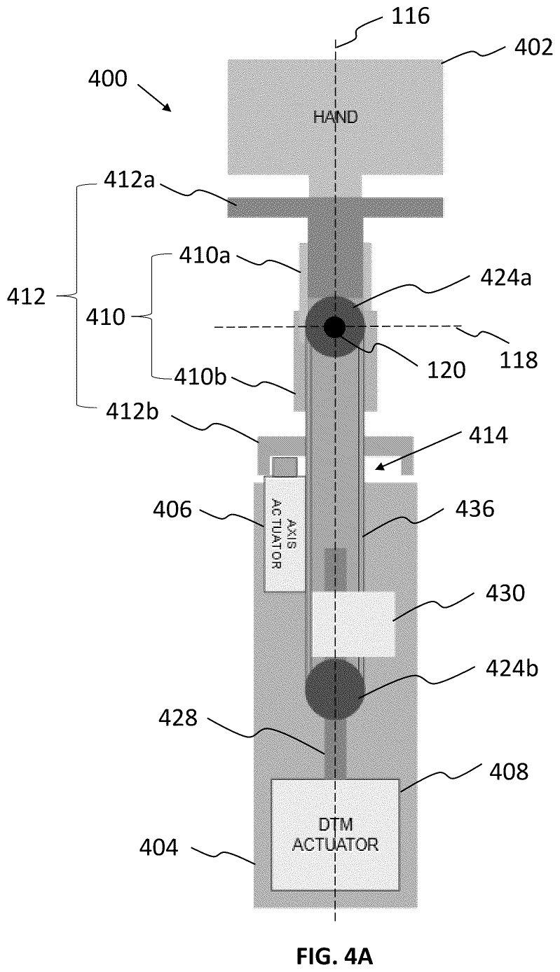

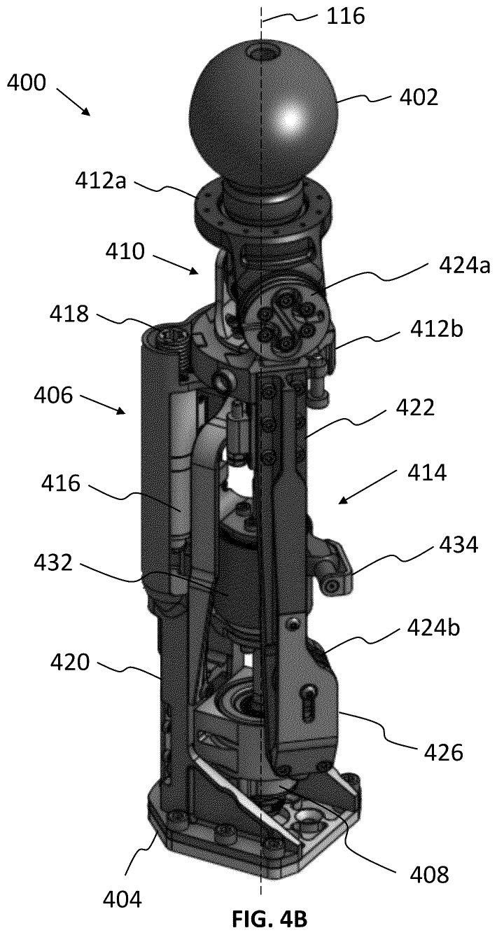

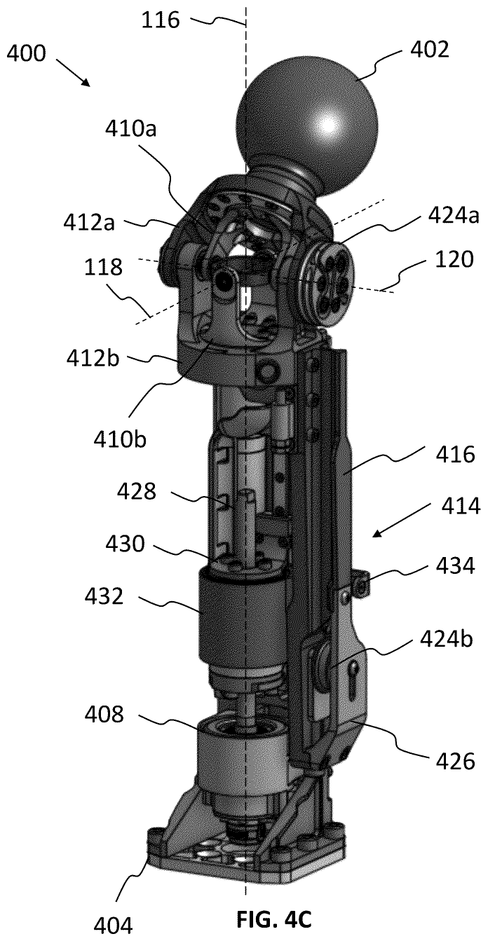

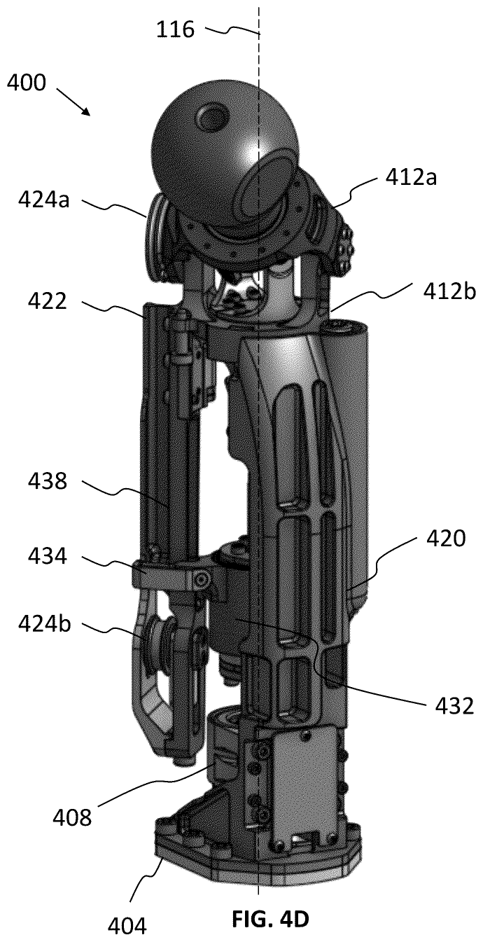

FIG. 4A illustrates an alternative embodiment of a robotic system 400 where the second actuator is relocated in addressing the aforementioned issues. FIGS. 4B-4D illustrate perspective views of the robotic system 400 in accordance with the alternative embodiment shown in FIG. 4A. Specifically, FIG. 4B shows the robotic system 400 in a natural position where the additional joint 412 and universal joint 410 are at a neutral orientation. FIGS. 4C and 4D illustrate a front perspective view and a rear perspective view of the robotic system 400 during the performance of the motion respectively.

The illustrated robotic system 400 generally includes a platform 402, a base 404, a first actuator 406, a second actuator 408, a universal joint 410 having a first universal joint part 410a and a second universal joint part 410b, an additional joint 412 having a first additional joint part 412a and a second additional joint part 412b, and a drive system 414. According to some implementations, and as shown in FIG. 4A, the second actuator 408 can be positioned adjacent to another end of the arm as opposed to the robotic system 100 as illustrated in FIG. 1A above, thereby reducing the rotational inertia of platform 402 or the base 404 during operation. The drive system 414 is an intermediary motion transmission device configured to transfer the actuation force or displacement generated by the second actuator 408 to the additional joint 412 operatively coupled to the second actuator 408.

According to some implementations, the platform 402 can be coupled to an upper end of the first universal joint part 410a of the universal joint 410, for example, through any interface feature as described herein (e.g., interface feature 206). The base 404 can be coupled to a lower end of the second universal joint part 410b of the universal joint 410. In some instances, the first universal joint part 410a and the second universal joint part 410b can be connected using a hollow spider (e.g., hollow spider 204). The first additional joint part 412a and the second additional joint part 412b are configured to swivel around axes that are coincident with the center of the universal joint. The second additional joint part 412b of the additional joint 412 is configured to be fixedly positioned at an angle around the axis 116. Further, the drive system 414 can be coupled to the second additional joint part 412b of the additional joint 412 and configured to control motion from the second actuator to the additional joint, enabling at least the platform 402, the first universal joint part 410a of the universal joint 410, and the first additional joint part 412a of the additional joint 412 to perform the motion around the additional joint 412.

In some instances, the additional joint 412 is configured to swivel around the axis based on operation of the first actuator 406. For example, as shown in FIG. 4B, the first actuator 406 includes a low-performance motor 416 and a capstan cable drive 418 operatively connected to the motor 416. The cable drive 418 is positioned to engage with the second additional joint part 412b of the additional joint 412. Specifically, the cable drive 418 contacts at least a portion of the outer circumference or surface of the second additional joint part 412b. The motor 416 is configured to deliver controlled rotational force (torque) to the cable drive 418. The first actuator 406 can be mounted vertically within the housing 420 to align the motor 416 with the axis 116, allowing a direct force application through the cable drive 418 to initiate the swivel motion. In some instances, the additional joint 112 is configured to swivel around the axis 116 within a range of motion between −90 degrees to 90 degrees.

The drive system 414, for example, can be a cable/belt transmission system that extends along the length of the base 404 between the additional joint 412 and the second actuator 408. In some implementations, the drive system 414 can be mounted on an elongated mounting bracket 422 vertically affixed to at least a portion of the circumference of the second additional joint part 412b of the additional joint 412 that is substantially flat. The drive system 414 includes a first pulley 424a coupled to the first additional joint part 412a of the additional joint 412 and a second pulley 424b coupled to the second additional joint part 412b of the additional joint 412. Specifically, the first pulley 424a is positioned adjacent to the universal joint 410 and the additional joint 412, while the second pulley 424b is coupled at a distal end 426 of the mounting bracket 422, proximate to the second actuator 408. The first pulley 424a includes grooves in the side configured to prevent the cable from slipping off. The first pulley 424a also includes additional grooves in the face, for example, S-shaped grooves configured to provide more friction. In this example, the mounting bracket 422 runs parallel to the base 404. The first pulley 424a can be mechanically attached to the coupling component (e.g., coupling component 208a) on one side of the additional joint 412, aligned coaxially with the central pin or axle (not shown) that passes through both the first and the second additional joint parts 412a-b of the additional joint 412.

In some implementations, as shown in FIG. 4C, the additional joint 412 is designed in an asymmetric form where one side extension is larger than another to accommodate the size and integration of the first pulley 424a. The enlarged side of the first additional joint part 412a provides additional mounting surface for the first pulley 424a for supporting the forces transferred through the first pulley 424a and the central pin or axle. In some cases, additional fasteners can be used to secure the first pulley 424a to the first additional joint part 412a of the additional joint 412. The mounting bracket 422 can include a recess or cavity along its length. The recess or cavity is located proximate to the end where the second pulley 424b is mounted and is configured to ensure that the first pulley 424a and the second pulley 424b (and their rotational axes) are aligned within the same vertical plane. For example, the mounting bracket 422 includes a rib configured to increase the stiffness of the mounting bracket 422.

In some instances, the second actuator 408 includes a linear actuator that is positioned vertically within the base 404. In these instances, a motor of the second actuator 408 can be positioned at a certain length away from the additional joint 412 and the universal joint 410, for example, at the bottom portion of the base 404, in order to reduce arm inertia. The second actuator includes a shaft 428 extending vertically towards the second additional joint part 412b of the additional joint 412 (or the second universal joint part 410b of the universal joint 410 or the platform 402) on which a carriage 430 is mounted and operable to move (e.g., up, and down) along the shaft 428 based on the operation of the second actuator 408. The shaft 428 is aligned with the axis 116 that is common to the additional joint 412 and the universal joint 410.

In some implementations, the carriage 430 includes an outer shell 432 and a bearing or bushing (not shown) positioned within the outer shell which allows the outer shell 432 to rotate round the shaft 428 as the additional joint 412 swivel around the axis 116. This synchronization is enabled through a coupling between the carriage 430 and the mounting bracket 422 which accommodates the drive system 414. Specifically, the drive system 414 further includes a guide member 434 affixed to the outer shell 432 of the carriage 430. The guide member 434 is a device configured to secure and align a flexible transmission element 436 (e.g., a continuous cable or a belt) of the drive system 414. The coupling further includes, as shown in FIG. 4D, an engagement between the guide member 434 and a rail interface 438 that extends along an edge of the mounting bracket 422. In some instances, the rail interface 438 includes a track or a channel that follows the vertical contour of the mounting bracket 422. For example, mounting bracket 422 can include a groove that runs longitudinally along the edge. Accordingly, the guide member 434 can include a corresponding sliding feature (e.g., a projection or a pin) that fits snugly within the track or the channel. The guide member 434 can move vertically along the track or the channel surface (without detaching) as the carriage 430 translates vertically along the shaft 428. That is, the guide member 434 is movably coupled to the mounting bracket 422 and simultaneously secured to the outer shell 432 of the carriage 430.

The guide member 434 as described herein can include, for example, a rigid slot, clamp, or a fixed passageway through which the cable or belt (not shown for clarity) passes. In operation, the guide member 434 interact with the cable or the belt and effective locks the cable or the belt with the vertical motion of the carriage 430. As the carriage 430 moves upward (towards the additional joint 412), the guide member 434 pulls the cable or the belt upward. Conversely, as the carriage 430 moves downward (away from the additional joint 412), the guide member 434 pulls the cable or the belt upward. It should be noted that the first pulley 424a is entirely fixed to the first additional joint part 412a of the additional joint 412, thus, the pulling action on the cable or the belt controlled by the guide member 434 can cause the additional joint 412 to articulate and perform the motion around additional joint 412. For example, when the cable or the belt is pulled downward, the first additional joint part 412a of the additional joint pivots around axis 120 in a flexion direction; however, when the cable or the belt is pulled upward, the first additional joint part 412a of the additional joint 412 pivots around axis 120 in an extension direction. In some instances, at least the platform 402, the first universal joint part 410a of the universal joint 410, the first additional joint part 412a of the additional joint 412, and the base 404 is configured to perform the motion around the additional joint 412 within a range of motion between −90 degrees to 90 degrees relative to the axis.

During operation, the swivel motion of the additional joint 412 round the vertical axis 116, driven by the first actuator 406, can causes the second additional joint part 412b of the additional joint 412 along with the mounting bracket 422 and rail interface 438 to rotate around the axis 116. However, due to the rotational freedom provided by the bearing or bushing within the outer shell 432, the guide member 434 can rotate around the shaft 428 without impeding the vertical translation of the carriage 430. Conversely, the oblique motion is independently achieved through the vertical translation of the carriage 430 along the shaft 428, driven by the second actuator 408. The guide member 434 can slide along the rail interface 438 without interfering with the rotational movement of the mounting bracket 422.

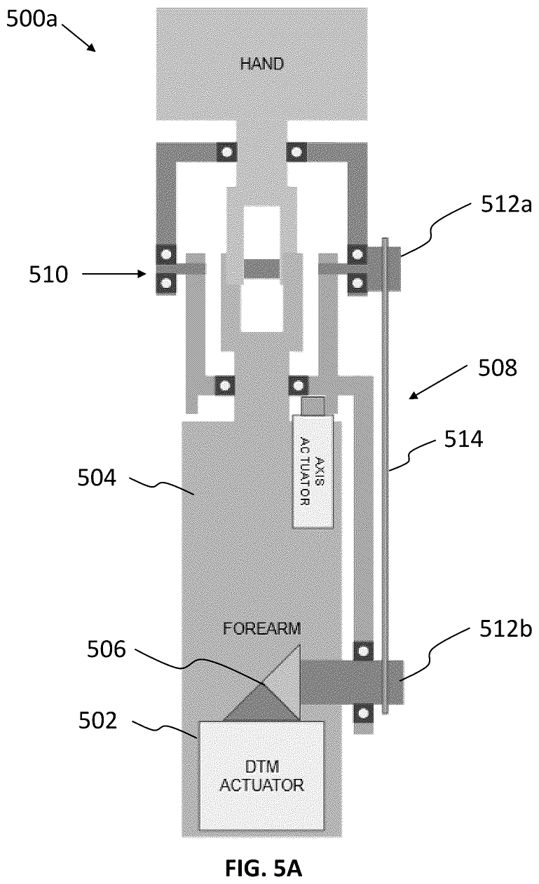

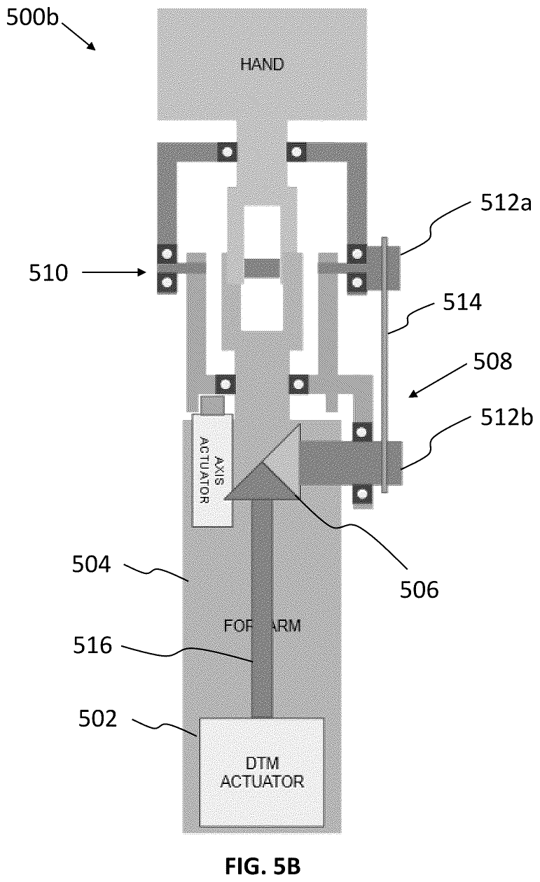

FIGS. 5A and 5B illustrate alternative embodiments of robotic systems 500a-b in which the second actuator is implement with a right-angle transmission. In the embodiment shown in FIG. 5A, the second actuator 502 is mounted in a stationary position within the arm 504. A right-angle transmission 506 connects the output of the second actuator 502 to the drive system 508 to control the motion around the additional joint 510. In some cases, the distance between the first pulley 512a and the second pulley 512b of the drive system 508 can be reduced, thereby reducing the length of the flexible transmission element 514 (e.g., the cable or belt). Accordingly, potential issues such as cable slack, elastic deformation, or misalignment can be minimized. Additionally, a shorter cable or belt may also improve the efficiency of force transmission by reducing energy losses caused by elongation or vibration. In such cases, as illustrated in the embodiment shown in FIG. 5B, the second actuator 502 can include a central vertical shaft 516 having a distal end coupled to the right-angle transmission 506 which position the right-angle transmission in close proximity to the relocated second pulley 512b of the drive system 508. In both embodiments, the right-angle transmission can include, for example, a bevel gear assembly or similar mechanism that redirects the torque generated by the second actuator 502 to align with the direction needed to operate the second pulley 512b of the drive system 508 while enabling the second actuator 502 to remain stationary. However, it should be noted that, in these embodiments, the rotation of the second additional joint part of the additional joint 510 is not decoupled from the rotation of the second actuator 502.

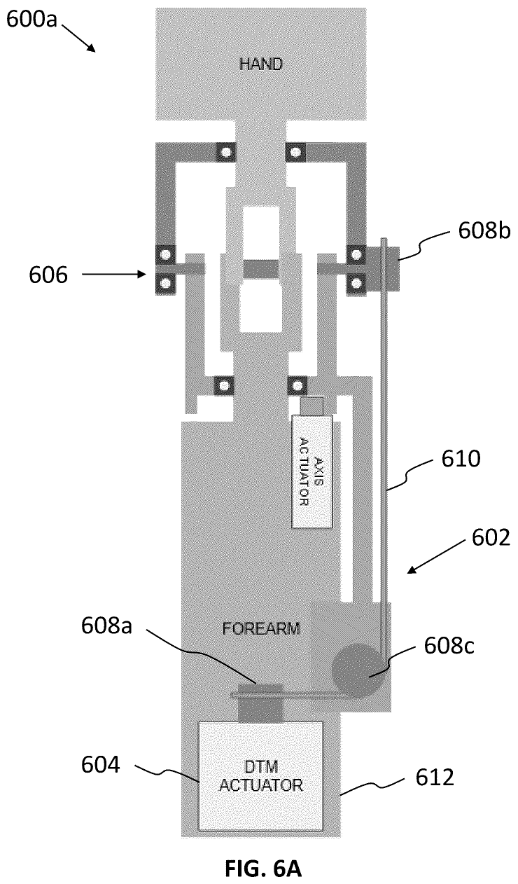

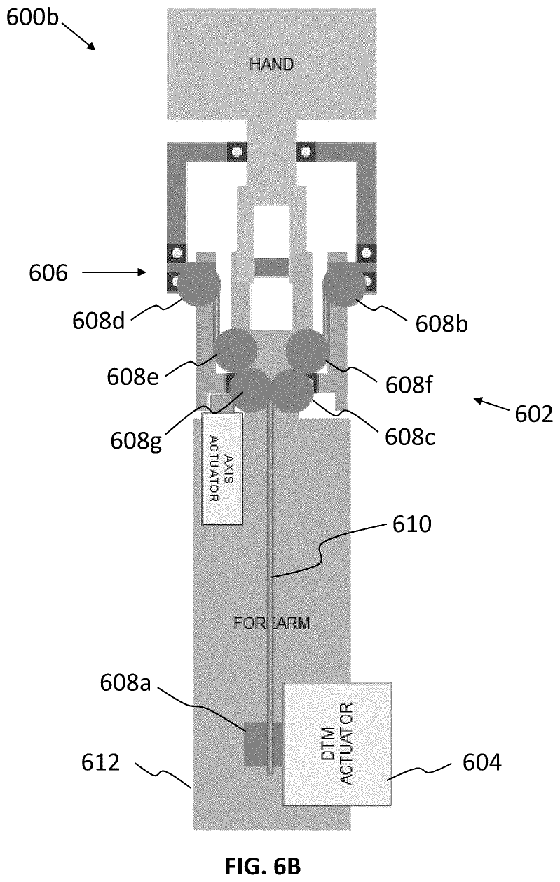

FIGS. 6A and 6B illustrate alternative embodiments of robotic systems 600a-b where the drive system 602 includes connecting pulleys arranged with non-parallel rotary axes to transfer torque from the second actuator 604 to the additional joint 606. In the embodiment shown in FIG. 6A, the drive system 602 can include a series of pulleys 608a-c connected via flexible transmission element 610 e.g., a belt or a cable to transmit rotational motion. The second actuator 604 can be positioned within the bottom portion of the arm 612 and drives the second pulley 608b mounted with a rotary axis that is vertically oriented. The belt or cable then extends to a first pulley 608a mounted on the additional joint 606 with a rotary axis that is horizontally oriented. A third pulley 608c with a rotary axis oriented perpendicularly to a primary path of the belt or cable, e.g., a redirect pulley, can be positioned adjacent to the second pulley 608b and the second actuator 604 to enable a directional change in the primary path (or a motion transmission path of the drive system 602). Such redirect pulley generally includes at least an input path in which the flexible transmission element 610 travels horizontally from the second pulley 608b to the first pulley 608a, and at least an output path in which the flexible transmission element 610 travels vertically from the first pulley 608a to the second pulley 608b. For example, the third pulley 608c can include a stack (more than one) of pulleys mounted coaxially but independently rotatable, configured to move the cable or belt in different direction. Similarly, in the embodiment shown in FIG. 6B, the drive system 602 can include additional pulleys 608d-g arranged with non-parallel rotary axes to further guide and transmit torque from the second actuator 604 to the additional joint 606, allowing flexible transmission element 610 to traverse non-linear paths due to potential space constraints. It should be noted that the rotation of the second additional joint part of the additional joint 606 is not decoupled from the rotation of the second actuator 604 in the embodiment as shown in FIG. 6A, while the rotation of the second additional joint part of the additional joint 606 is decoupled from the rotation of the second actuator 604 in the embodiment as shown in FIG. 6B, at least because the cable twists within the drive system 602.

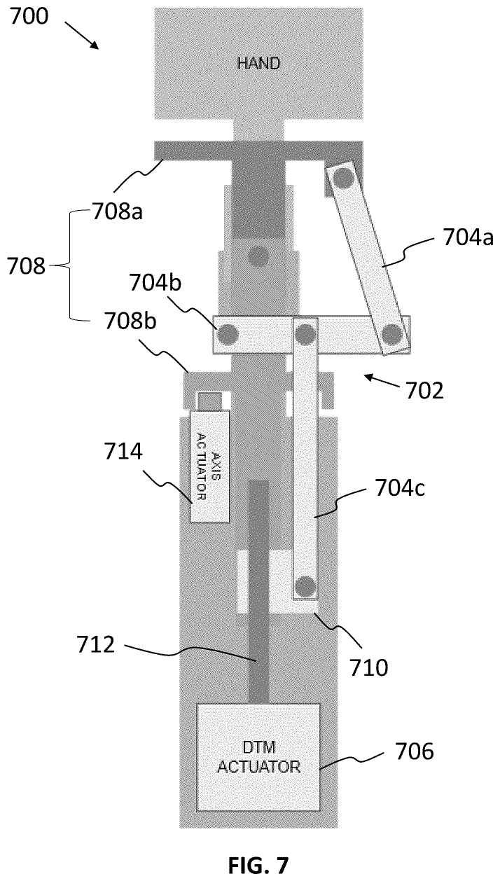

FIG. 7 illustrates an embodiment of a robotic system 700 where the drive system 702 includes a series of rigid transmission elements 704a-c, configured to transfer toque from the second actuator 706 to the additional joint 708 in replace of the flexible transmission elements as described above with reference to FIGS. 4A-D. In some implementations, the drive system 702 can include a first rigid transmission element 704a (e.g., a first rigid link) having one end pivotally coupled to the first additional joint part 708a of the additional joint 708. The drive system 702 can also include a second rigid transmission element 704b (e.g., a second rigid link) having one end pivotally coupled to the second additional joint part 708b of the additional joint 708 and another end pivotally coupled to the first rigid transmission element 704a. The drive system 702 further include a third rigid transmission element 704c (e.g., a third rigid link) having an end affixed to the (outer shell of) carriage 710 movably coupled to the shaft 712 (e.g., a ball screw assembly) extending vertically from the second actuator 706 and another end pivotally coupled to the body of the second rigid transmission element 704b.

The rigid transmission elements 704a-c are configured to work in concert to enable the motion as described herein while the second actuator 604 drives the carriage 710 to translate vertically along the shaft 712. The movement of the carriage 710 (i.e., the movement of the third rigid transmission element 704c) causes the second rigid transmission element 704b to pivot about its connection with the second additional joint part 708b of the additional joint 708, which, in turn, propagates to the first rigid transmission element 704a. The first rigid transmission element 704a pivots about its connection to the first additional joint part 708a of the additional joint 708. Additionally, the linear motion of the carriage 710 remains decoupled from the swivel motion of the additional joint 708 (driven by the first actuator 714) since the outer shell of the carriage 710 can rotate round the shaft 712. Further, the use of rigid transmission elements 704a-c in drive system 702 provides significant benefits in terms of cable routing.

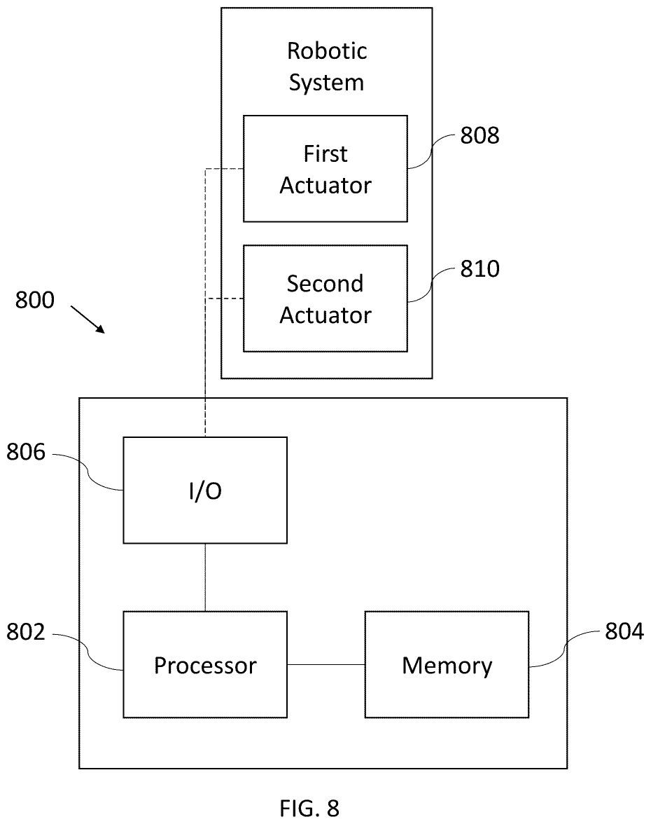

FIG. 8 illustrates an example controller 800 that can be used with some aspects of the current subject matter. The controller 800 can, among other things, monitor operational parameters of the robotic system as described herein and send signals to actuate and/or adjust components of the robotic system to facilitate the motion as described herein. As shown in FIG. 8, the controller 800 can include one or more processors 802 and non-transitory computer readable memory storage (e.g., memory 804) containing instructions that cause the processors 802 to perform operations. The processors 802 are coupled to an input/output (I/O) interface 806 for sending and receiving communications with components in the system, including, for example, the first actuator 808, the second actuator 810, as well as other sensors that provide operational feedback to the robotic system. The controller 800 can be implemented with various levels of autonomy. In some implementations, the controller 800 alerts an operator that a parameter, such as the position or the velocity of the additional joint or the universal joint relative to the axis of compliance or any other axes, is out of specification. The operator can provide input to adjust operating parameters, for example, to update actuator settings. In fully autonomous implementations, the controller 800 can monitor the operational parameters in real0time and determines adjustments without operator input. For example, if sensor data received by the processors 802 indicate a misalignment between the first actuator 808 and the second actuator 810, the controller 800 can modify actuator inputs to compensate to ensure synchronized operation of the robotic system.

Certain illustrative implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting illustrative implementations and that the scope of the present invention is defined solely by the claims. The features illustrated or described in connection with one illustrative implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed:

1. A robotic system comprising:
a base, a platform, a first actuator, and a second actuator;
a universal joint including a first universal joint part and a second universal joint part; and
an additional joint including a first additional joint part and a second additional joint part;
wherein:
an end of the first universal joint part of the universal joint is coupled to the base and an end of the second universal joint part of the universal joint is coupled to an end of the base;
the first additional joint part and the second additional joint part are configured to swivel around axes that are coincident with a center of the universal joint;
the second additional joint part of the additional joint is operable to be fixedly positioned at an angle around an axis of the additional joint that is coincident with the center of the universal joint; and
at least the platform, the first universal joint part of the universal joint, and the first additional joint part of the additional joint are operable to perform a motion around the additional joint.

2. The robotic system of claim 1, wherein the platform is positioned in a vertical orientation that aligns with the axis of the additional joint that is perpendicular to the axes that are coincident with the center of the universal joint.

3. The robotic system of claim 2, wherein the platform maintains the vertical orientation aligning with the axis of the additional joint as the additional joint swivels around the axes that are coincident with the center of the universal joint.

4. The robotic system of claim 1, wherein the additional joint is operable to swivel around the axes that are coincident with the center of the universal joint based on operation of the first actuator.

5. The robotic system of claim 1, wherein the first additional joint part of the additional joint is operable to perform the motion around the additional joint upon the fixing of the second additional joint part of the additional joint at the angle around the axis of the additional joint.

6. The robotic system of claim 5, wherein at least the platform, the first universal joint part of the universal joint, and the first additional joint part of the additional joint are operable to perform the motion around the additional joint based on operation of the second actuator.

7. The robotic system of claim 1, wherein the additional joint is coupled to the universal joint, the coupling comprises:
a coupling between the first additional joint part of the additional joint and the first universal joint part of the universal joint using a first bearing; and
a coupling between the second additional joint part of the additional joint and the second universal joint part of the universal joint using a second bearing.

8. The robotic system of claim 7, wherein:
the first additional joint part of the additional joint is operable to swivel around the axis of the additional joint using the first bearing; and
the second additional joint part of the additional joint is operable to swivel around the axis of the additional joint using the second bearing.

9. The robotic system of claim 1, wherein the angle around the axis of the additional joint is between −90 degrees to 90 degrees.

10. The robotic system of claim 1, wherein the universal joint further comprises:
a hollow spider positioned between the first universal joint part and the second universal joint part of the universal joint, the hollow spider being configured to provide a connection between the first universal joint part and the second universal joint part of the universal joint and a passage for cables through the universal joint.

11. The robotic system of claim 1, wherein at least the platform, the first universal joint part of the universal joint, and the first additional joint part of the additional joint are operable to perform the motion around the additional joint within a range of motion between −90 degrees to 90 degrees.

12. The robotic system of claim 1, wherein the second actuator is positioned between the first additional joint part and the second additional joint part.

13. The robotic system of claim 1, wherein the first actuator is positioned adjacent to the base.

14. A robotic system comprising:
a base, a platform, a first actuator, and a second actuator;
a universal joint including a first universal joint part and a second universal joint part;
an additional joint including a first additional joint part and a second additional joint part; and
a drive system;
wherein:
an end of the first universal joint part of the universal joint is coupled to the base and an end of the second universal joint part of the universal joint is coupled to an end of the base;
the first additional joint part and the second additional joint part are configured to swivel around axes that are coincident with a center of the universal joint;
the second additional joint part of the additional joint is operable to be fixedly positioned an angle around an axis of the additional joint that is coincident with the center of the universal joint; and
the drive system is coupled to the second additional joint part of the additional joint and the base, and operable to control motion from the second actuator to the additional joint, enabling at least the platform, the first universal joint part of the universal joint, and the first additional joint part of the additional joint to perform a motion around the additional joint.

15. The robotic system of claim 14, wherein the second actuator is positioned adjacent to another end of the base.

16. The robotic system of claim 14, wherein the drive system comprises:
a first pulley coupled to the first additional joint part of the additional joint, wherein the first pulley is positioned adjacent to the universal joint and the additional joint;
a second pulley coupled to the second additional joint part of the additional joint, wherein the second pulley is positioned proximate to the second actuator;
a guide member affixed to a carriage movably coupled to an extending shaft of the second actuator, wherein the guide member is operable to displace a flexible transmission element operatively connected between the first pulley and the second pulley along a axis of the extending shaft extends along, and wherein the axis of the extending shaft extends along is coincident with the center of the universal joint.

17. The robotic system of claim 16, wherein the flexible transmission element comprises a continuous cable or belt.

18. The robotic system of claim 14, wherein the drive system comprises:
a plurality of rigid transmission elements operatively connected between the additional joint and the second actuator, wherein the plurality of rigid transmission elements comprises:
a first rigid transmission element having an end pivotally coupled to the first additional joint part of the additional joint;
a second rigid transmission element having an end pivotally coupled to the second additional joint part of the additional joint and another end pivotally coupled to the first rigid transmission element; and
a third rigid transmission element having an end affixed to a carriage movably coupled to an extending shaft of the second actuator and another end pivotally coupled to the second rigid transmission element.

19. The robotic system of claim 14, wherein the angle around the axis of the additional joint is between −90 degrees to 90 degrees.

20. The robotic system of claim 14, wherein at least the platform, the first universal joint part of the universal joint, and the first additional joint part of the additional joint are operable to perform the motion around the additional joint within a range of motion between −90 degrees to 90 degrees.
